(19) United States
(12) Patent Application Publication
(10) Pub. No.: US 2007/0135256 A1
(43) Pub. Date: Jun. 14, 2007

(54) Harmonic Friction Drive Method and Apparatus

(76) Inventor: Brett Carl Beaudoin, Corinth, TX (US)

Correspondence Address: BRETT CARL BEAUDOIN, 1662 KNOLL RIDGE CIR., CORINTH, TX, 76210, US

(21) Appl. No.: 11/608,825

(22) Filed: Dec. 9, 2006

Related U.S. Application Data
(60) Provisional application No. 60/597,564, filed on Dec. 10, 2005.

(51) Int. Cl. F16H 59/00

(52) U.S. Cl. 476/1; 310/317

(57) ABSTRACT

A longitudinal wave traveling within a compressible elastic body which is in frictional contact with the surface of a relatively rigid body, near at least one region of the elastic body which is encountering a specific phase of the longitudinal wave, and having a propagation velocity component parallel to the surface of the rigid body, generates shear in the rigid body thereby resulting in displacement of the rigid body. An apparatus utilizing this method for transferring motion between two frictionally contacting bodies is also described.

### CROSS-REFERENCE TO RELATED APPLICATIONS

U.S. Provisional Application No. 60/597564, filed Dec. 10, 2005

### BACKGROUND OF THE INVENTION

The present invention relates to a method for using longitudinal strain waves in a compressible elastic body to displace another body with which said elastic body is in frictional contact and to a harmonic friction drive apparatus utilizing said method. Friction drives have existed for a long time and harmonic drives have existed since the late 1950's. Some prior art systems have incorporated aspects of each.

In several prior art systems (including U.S. Pat. No. 2,906,143) either a flexible splined cylinder or flexible splined disk is deformed by various methods such that one or more teeth are engaged against another, usually coaxial, rigid splined surface. The flexible member is usually restricted from rotating while the object or device that created the deformation is rotated. With each rotation of this device, a transverse wave is moved along the flexible member, causing the rigid member to offset with respect to the flexible member by a small angle. While such a speed reducer is advantageous because it provides significant speed reduction in a single stage and is reversible so that it can also be used as a speed multiplier, the annular configuration limits the speed reduction to a single ratio, and it can be fabricated only at comparatively high cost.

Any gear system is inherently limited to specific speed ratios since the number of teeth is fixed whereas infinitely variable ratios can be easily obtained with a friction drive. Also, the high precision required of the gear teeth in current harmonic drives results in high production costs. By contrast, frictional drive mechanisms are relatively inexpensive to manufacture.

To date, harmonic drives require a generally incompressible elastic body. The present invention requires a compressible material be used for the elastic body, allowing for a wider variety of materials. Additionally, using a non-annular, disk-like configuration presents the possibility for adjustment of the drive radius and therefore the speed ratio.

In prior art friction drive systems, at the point of contact between two bodies in static frictional contact, the relative velocities and acceleration are equal. It is at this point of contact that motion in one body is transferred to the other. These arrangements require continuous shear forces within the frictional surface materials. This means that the input body must be in motion for the output body to be in motion. In the present invention, harmonic shear forces resulting from longitudinal strain waves produce motion in the second body. Therefore, displacement of the elastic body as a whole is not required in order to generate motion in the output body.

In another prior art system (U.S. Pat. No. 4,227,608) one or more transverse waves are caused to move along one active portion of at least one body, the active portion of which is in contact with another body. This wave formation either causes an interruption in the contact between the bodies and separates two parts of the active portion which is in contact with the other body, or forms a contact between the bodies and separates two parts of the active portion which are not in contact with the other body. The distance between two arbitrarily selected points of respective pairs of the separated parts measured along the surface of the active portion will then be longer than the shortest distance between the same points. Certain applications may preclude the use of transverse waves within the elastic body due to material, space, or other constraints. In these applications the present invention would have an advantage.

### BRIEF SUMMARY OF THE INVENTION

The primary objective of the present invention is to provide a method by which motion can be transferred between two frictionally contacting bodies and with which the aforementioned disadvantages are eliminated or greatly reduced.

### BRIEF DESCRIPTION OF THE DRAWINGS

So that the present invention will be more readily understood and optional features thereof made apparent, preferred embodiments of the present invention will now be described with reference to the accompanying schematic drawings.

FIG. 1 illustrates the principle by which longitudinal strain waves in a compressible elastic body (1) are used to produce a displacement (delta S) in another body (2) with which it is in frictional contact.

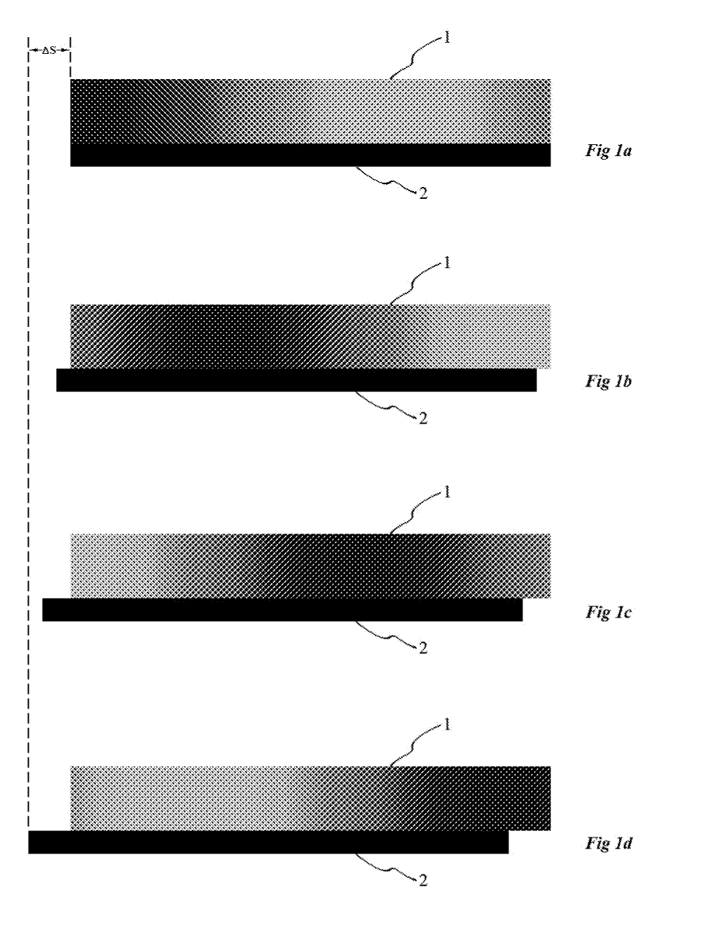

FIG. 2 illustrates an improvement in the aforementioned principle by deflection of an elastic body (1) into frictional contact with another body (2) only near the expansion phase of the longitudinal wave. This reduces the kinetic friction which causes wear and increases the overall efficiency of the device.

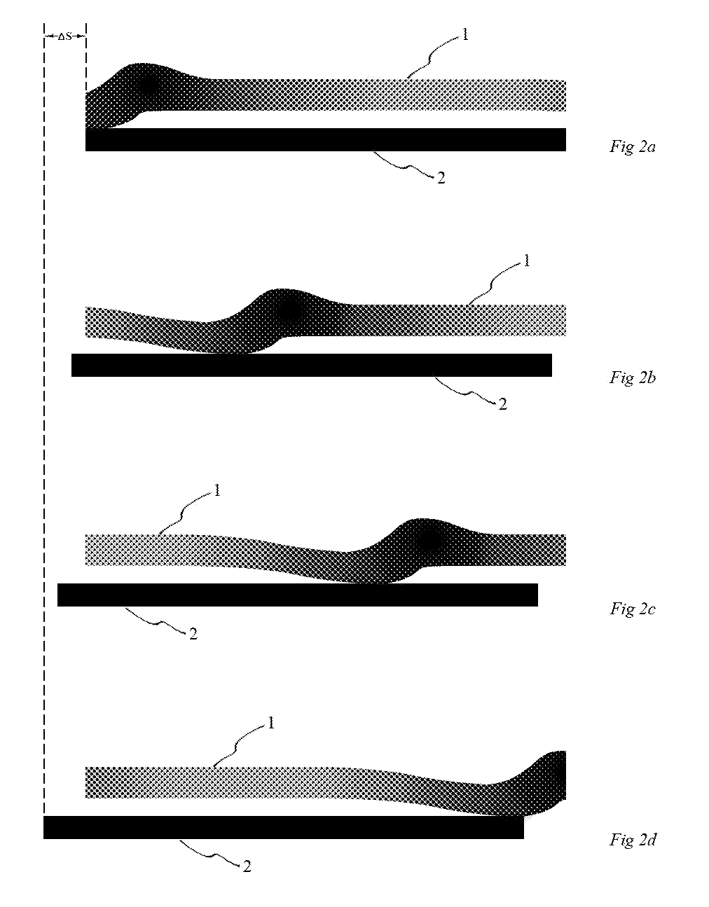

FIG. 3 is a sectional view of a preferred embodiment using the method of the present invention as a rotary speed reducer and clutch. A wave generator assembly (1) is caused to rotate freely within a housing (6). Axial thrust applied to the wave generator assembly into contact with a compressible elastic membrane (3) which, in turn, gets compressed between the wave generator and the disk-shaped output rotor (4). Continued rotation of the wave generator causes a longitudinal wave to propagate in a continuous path around the axis of rotation. As previously explained, this wave results in the rotation of the output rotor at a greatly reduced speed and in the direction opposite that of the input shaft of the wave generator assembly. It should be apparent to any person skilled in this area that this arrangement may also be used as an infinitely variable transmission simply by adjusting the distance (X) between the axis of the input shaft and the point of contact between the compressible elastic membrane (3) and the output rotor (4).

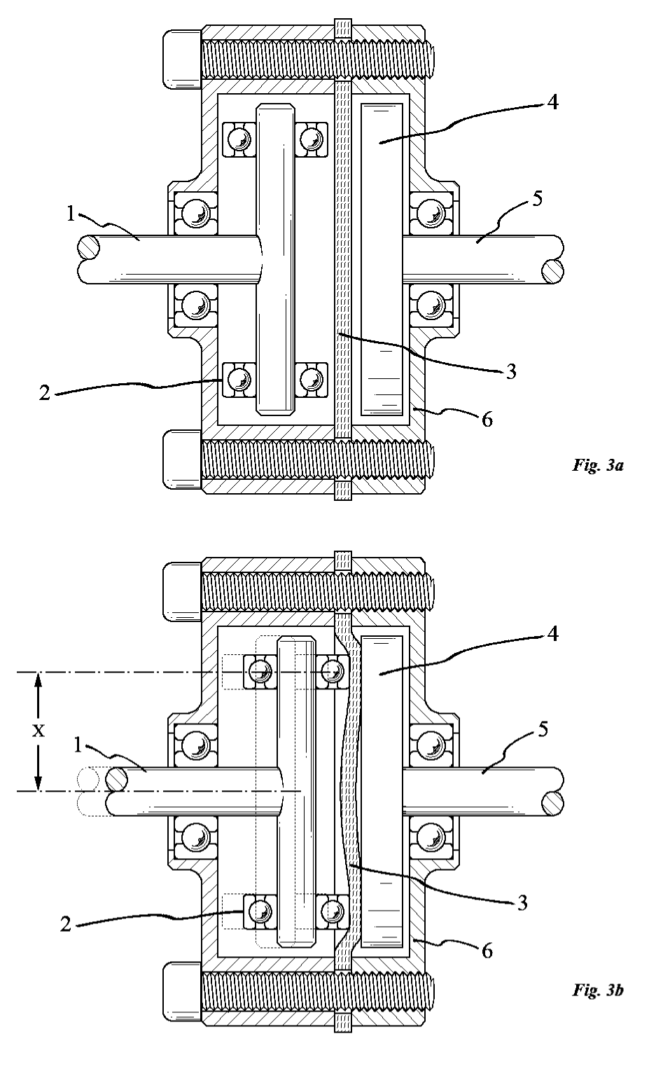

### DETAILED DESCRIPTION OF THE INVENTION

At least one longitudinal wave is caused to travel through a compressible elastic body. Frictional contact between said elastic body and the surface of a relatively rigid body, specifically near a region of the elastic body where the longitudinal wave is beginning either its expansion phase or its compression phase, generates shear in the rigid body in the direction opposite the longitudinal wave's propagation. Said rigid body could be, for example, the ground, or a rotatable disk, drum, or ring. The friction in said region of the elastic body must be greater than the friction elsewhere between the two bodies. This may be accomplished by a number of means including, but not limited to, constraint of the elastic body's thickness or deflection of either body toward the other, thereby causing increased normal force near the longitudinal wave's peak.

The present invention also relates to an apparatus for use with the method of transferring motion between two frictionally contacting bodies. Such an apparatus is based on the use of longitudinal waves, in accordance with the definition above, which are advanced in a compressible elastic body which is substantially stationary relative to the body in contact therewith. Each longitudinal wave tends to provide a relative displacement of the body with which the compressible elastic body is in contact in the direction opposite the longitudinal wave propagation in a manner somewhat similar to the peristaltic locomotion of an earthworm.

The compressible elastic body may form a straight path. Such a configuration could be used in a linear actuator, a conveyor system, or an automotive propulsion system similar to those found on caterpillar-type heavy equipment. Alternatively, the compressible elastic body may have the form of a continuous path in which longitudinal waves are caused to circulate. Such a configuration could be used in lieu of traditional transmissions in, for example, automobiles, self-propelled toys, lawn equipment, and the like.

The longitudinal waves can be initiated and/or advanced by means of at least one rolling or translating body or a translating fluid jet, temperature differential, or other source of pressure which is displaceable relative to the compressible elastic body.

What is claimed is:

1. A method by which motion can be transferred from a compressible elastic body to a relatively rigid body with which it is in frictional contact wherein at least one longitudinal wave is caused to travel through the elastic body resulting in shear and therefore displacement of the rigid body.

2. An apparatus comprising a compressible elastic body and a relatively rigid body with which it is in frictional contact, wherein at least one longitudinal wave is caused to travel through the elastic body resulting in shear and therefore displacement of the rigid body.

3. The apparatus of claim 2 wherein the direction of propagation of the longitudinal wave is held constant resulting in linear displacement of the rigid body.

4. The apparatus of claim 3 wherein the ratio of the speeds of the longitudinal wave and the rigid body is changed by varying the amplitude of the longitudinal wave.

5. The apparatus of claim 3 wherein the ratio of the speeds of the longitudinal wave and the rigid body is changed by varying the physical properties of the elastic body.

6. The apparatus of claim 3 wherein the ratio of the speeds of the longitudinal wave and the rigid body is changed by varying the phase of the longitudinal wave nearest the area of contact between the two bodies.

7. The apparatus of claim 3 wherein the direction of displacement of the rigid body is changed by varying the phase of the longitudinal wave nearest the area of contact between the two bodies.

8. The apparatus of claim 2 wherein the direction of propagation of the longitudinal wave is continuously changed resulting in angular displacement of the rigid body about a center of rotation.

9. The apparatus of claim 8 wherein the ratio of the speeds of the longitudinal wave and the rigid body is changed by varying the radial distance of the point or region of frictional contact from the center of rotation.

10. The apparatus of claim 8 wherein the ratio of the speeds of the longitudinal wave and the rigid body is changed by varying the amplitude of the longitudinal wave.

11. The apparatus of claim 8 wherein the ratio of the speeds of the longitudinal wave and the rigid body is changed by varying the physical properties of the elastic body.

12. The apparatus of claim 8 wherein the ratio of the speeds of the longitudinal wave and the rigid body is changed by varying the phase of the longitudinal wave nearest the area of contact between the two bodies.

13. The apparatus of claim 8 wherein the direction of rotational displacement of the rigid body is changed by varying the phase of the longitudinal wave nearest the area of contact between the two bodies.
